(19) United States
(12) Patent Application Publication
(10) Pub. No.: US 2009/0061049 A1
(43) Pub. Date: Mar. 5, 2009

(54) Feed compositions for aquatic animals and methods of making the same

(76) Inventor: Vadood Azarm, Katy, TX (US)

Correspondence Address: T.R. Kruegar, P.C., P.O. Box 16356, Sugar Land, TX, 77496, US

(21) Appl. No.: 11/895,874

(22) Filed: Aug. 28, 2007

(51) Int. Cl. A23L 1/325; A23L 1/326

(52) U.S. Cl. 426/62

(57) ABSTRACT

Feed compositions for aquatic animals and methods of forming the same are discussed herein. The feed compositions generally include lettuce powder, yeast and fish meal. In one embodiment, the feed composition further includes industrial eggs.

### FIELD

Embodiments of the present invention generally relate to feed compositions for aquatic animals.

### BACKGROUND

As reflected in the patent literature, aquatic feed compositions have experienced problems with aquarium pollution and/or unattractiveness of aquatic animals to be attracted to the feed compositions.

Therefore, a need exists to develop a feed composition desirable to aquatic animals without such difficulties.

### SUMMARY

Embodiments of the present invention include feed compositions for aquatic animals. The feed compositions generally include lettuce powder, yeast and fish meal. In one embodiment, the feed composition further includes industrial eggs. In one embodiment, the feed composition further includes worm powder.

Embodiments of the invention further include methods of forming the feed compositions. The methods generally include dry mixing and forming the resulting powder into pellets.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

Embodiments of the invention generally include feed compositions for aquatic animals. The aquatic animals may include, for example, fish, shrimp and invertebrates. The aquatic animals may live in any body of water, such as fresh water or sea water, in tanks, farms or natural bodies of water, for example.

The feed composition generally includes yeast. In one embodiment, the yeast is of the species saccharomyces cerevisiae, for example. The yeast may be present in an amount of from about 2700 g. to about 3300 g., or from about 2900 g. to about 3100 g. of from about 2975 g. to about 3125 g., for example.

The feed composition further includes fish meal. As used herein, the term “fish meal” refers to the clean rendered, dried ground tissue of undecomposed whole fish or fish cuttings with or without the extraction of part of the oil. The fish meal is generally in powder form. The term “powder” refers to a dry, bulk solid composed of a large number of very fine particles that may flow freely when shaken or tilted. In particular, powders refer to those granular materials that have a fine grain sizes and therefore have a greater tendency to form clumps when flowing. In one embodiment, the fish powder is formed of a fish having little oil, such as sardines. The fish powder may be present in an amount of from about 225 g. to about 275 g. or from about 235 g. to about 260 g., for example.

The feed composition may also include industrial eggs. As used herein, the term “industrial eggs” refers to eggs that have been mechanically broken and the liquid contents separated from the shell. In one embodiment, the industrial eggs are dried. The industrial eggs may be present in an amount of from about 22.5 g to about 27.5 g. or from about 24 g. to about 26 g., for example.

The feed composition may also include lettuce powder. As used herein, the term “lettuce” may refer to lettuce from any source, such as from the sea or from land. The lettuce powder may be present in an amount of from about 22.5 g to about 27.5 g. or from about 24 g. to about 26 g., for example.

The feed composition may also include worm powder. In one embodiment, the worm powder includes red worm powder. The worm powder may be present in an amount of from about 2.25 g. to about 2.75 g. or from about 2.40 g. to about 2.60 g., for example.

The feed composition may further include a binder material. The binder material may include a glass material, such as silica. As used herein, the term “glass” refers to a uniform material produced when the viscous molten material cools very rapidly to below its glass transition temperature without sufficient time for a regular crystal lattice to form. The binder may be present in an amount of from about 22.5 g. to about 27.5 g. or from about 24.0 g. to about 26.0 g., for example.

In addition, the feed composition may include other additives as known to ones skilled in the art, such as vitamins, minerals, coloring, aroma materials and preservatives, for example.

In one embodiment, the components of the feed composition are dry mixed and then pressed into tablets. The components may be dry mixed for a time of from about 1 min. to about 10 min., of from about 1 min. to about 5 min. or from about 2 min. to about 3 min., for example.

The tablets may be of a size known to one skilled in the art. For example, the tablets may be of a size of from about 50 g. to about 300 g. or from about 100 g. to about 250 g., for example.

In one embodiment, the tablet is flat on opposing sides.

The feed composition generally includes a minimal amount of water, such as less than about 2.5 wt. % water. Therefore, the tablets may be air dried or dried via other methods to remove water therefrom. For example, the tablets may be put into an oven.

It has been observed that fish grow quickly and are attracted to the feed formed from the embodiments described herein. Further, the feed is digested quickly, thereby preventing the build up of intestinal gas, renal failure and infections. The embodiments further avoid aquarium pollution due to excessive ammonia.

While the foregoing is directed to embodiments of the present invention, other and further embodiments of the invention may be devised without departing from the basic scope thereof and the scope thereof is determined by the claims that follow.

What is claimed is:

1. A feed composition for aquatic animals comprising:
lettuce powder;
yeast; and
fish meal.

2. The feed composition of claim 1, wherein the feed composition comprises from about 22.5 g. to about 27.5 g. lettuce powder.

3. The feed composition of claim 1, wherein the feed composition comprises from about 2700 g. to about 3300 g. yeast.

4. The feed composition of claim 1, wherein the yeast comprises saccharomyces cerevisiae.

5. The feed composition of claim 1, wherein the feed composition comprises from about 225 g. to about 275 g. fish meal.

6. The feed composition of claim 1, wherein the fish meal comprises sardines.

7. The feed composition of claim 1 further comprising industrial eggs.

8. The feed composition of claim 7, wherein the feed composition comprises from about 22.5 g. to about 27.5 g. industrial eggs.

9. The feed composition of claim 1 further comprising worm powder.

10. The feed composition of claim 9, wherein the feed composition comprises from about 2.25 g. to about 2.75 g. worm powder.

11. The feed composition of claim 1 further comprising a binder material.

12. The feed composition of claim 11, wherein the feed composition comprises from about 22.5 g. to about 27.5 g. binder material.

13. The feed composition of claim 11, wherein the binder material comprises silica.

14. The feed composition of claim 1, wherein the feed composition is in the form of pellets.

15. The feed composition of claim 1, further comprising less than about 2.5 wt. % water.

16. A feed composition for aquatic animals comprising:
lettuce powder;
yeast;
fish meal;
industrial eggs; and
worm powder.

17. The feed composition of claim 16 further comprising silica.

18. A method of forming a feed composition for aquatic animals comprising:
dry mixing lettuce powder, yeast, fish meal, industrial eggs and worm powder together to form a powder; and
forming the powder into pellets.
